(19) United States
(12) Patent Application Publication
(10) Pub. No.: US 2011/0027067 A1
(43) Pub. Date: Feb. 3, 2011

(54) COATED SHROUDED WIND TURBINE

(75) Inventors: Thomas J. Kennedy, III, Wilbraham, MA (US); Walter M. Presz, JR., Wilbraham, MA (US); Michael J. Werle, West Hartford, CT (US)

Correspondence Address: FAY SHARPE LLP, 1228 Euclid Avenue, 5th Floor, The Halle Building, Cleveland, OH, 44115, US

(73) Assignee: FLODESIGN WIND TURBINE CORPORATION, Wilbraham, MA (US)

(21) Appl. No.: 12/794,423

(22) Filed: Jun. 4, 2010

Related U.S. Application Data
(63) Continuation-in-part of application No. 12/555,446, filed on Sep. 8, 2009.
Application No. 12/555,446 is a continuation-in-part of application No. 12/054,050, filed on Mar. 24, 2008.
(60) Provisional application No. 61/184,289, filed on Jun. 4, 2009.
(60) Provisional application No. 61/191,358, filed on Sep. 8, 2008.
(60) Provisional application No. 60/919,588, filed on Mar. 23, 2007.

(51) Int. Cl. F03D 11/00

(52) U.S. Cl. 415/4.1

(57) ABSTRACT

A wind turbine has an impeller surrounded by a shroud. The shroud includes an interior surface and an exterior surface. The surface is coated with a silicone polyurethane polymer. The resulting surface has reduced surface energy, and can shed rain, snow, and ice more easily.

This application claims priority to U.S. Provisional Patent Application Ser. No. 61/184,289, filed Jun. 4, 2009. This application is also a continuation-in-part application of U.S. patent application Ser. No. 12/555,446, filed Sep. 8, 2009, which claims priority from U.S. Provisional Patent Application Ser. No. 61/191,358, filed on Sep. 8, 2008. This application is also a continuation-in-part from U.S. patent application Ser. No. 12/054,050, filed Mar. 24, 2008, which claimed priority from U.S. Provisional Patent Application Ser. No. 60/919,588, filed Mar. 23, 2007. The disclosure of these applications is hereby fully incorporated by reference in their entirety.

### BACKGROUND

The present disclosure relates to coatings, such as silicone polyurethane coatings, for use with a shrouded wind turbine. The coatings provide a low energy surface that allow atmospheric deposits such as rain, snow, ice, sand, dirt, etc. to be shed or dispersed more easily. The coatings also help maintain the aerodynamic properties of the shrouded wind turbine.

Conventional wind turbines used for power generation generally have two to five open blades arranged like a propeller, the blades being mounted to a horizontal shaft attached to a gear box which drives a power generator. Such turbines are generally known as horizontal axis wind turbines, or HAWTs. Although HAWTs have achieved widespread usage, their efficiency is not optimized. In particular, they will not exceed the Betz limit of 59.3% efficiency in capturing the potential energy of the wind passing through it.

Conventional wind turbines have three blades and are oriented or pointed into the wind by computer controlled motors. These turbines typically require a supporting tower ranging from 60 to 90 meters in height. The blades generally rotate at a rotational speed of about 10 to 22 rpm. A gear box is commonly used to step up the speed to drive the generator, although some designs may directly drive an annular electric generator. Some turbines operate at a constant speed. However, more energy can be collected by using a variable speed turbine and a solid state power converter to interface the turbine with the generator.

Several problems are associated with HAWTs in both construction and operation. The tall towers and long blades are difficult to transport. Massive tower construction is required to support the heavy blades, gearbox, and generator. Very tall and expensive cranes and skilled operators are needed for installation. In operation, HAWTs require an additional yaw control mechanism to turn the blades toward the wind. HAWTs typically have a high angle of attack on their airfoils that do not lend themselves to variable changes in wind flow. HAWTs are difficult to operate in near ground, turbulent winds. Ice build-up on the nacelle and the blades can cause power reduction and safety issues. Tall HAWTs may affect airport radar. Their height also makes them obtrusively visible across large areas, disrupting the appearance of the landscape and sometimes creating local opposition. Finally, downwind variants suffer from fatigue and structural failure caused by turbulence.

It would be desirable to reduce the build-up of snow and/or ice on a wind turbine.

### BRIEF DESCRIPTION

The present disclosure relates to coatings that can be used on one or more components of a shrouded wind turbine. The coating is a polyurethane polymer having silicon in its backbone. The coating forms a microlayer on the surface of one or more components of the wind turbine, such as a wind turbine shroud. This allows the shroud to shed deposits from the atmosphere, such as water, ice, snow, sand, dirt, etc., or combinations thereof, more easily. This increases the overall safety of the shrouded wind turbine and maintains energy generation capability in different climates and conditions.

Disclosed in embodiments is a wind turbine comprising an impeller and a first shroud located concentrically about the impeller. The first shroud includes a surface having a low surface energy coating disposed thereon. The low surface energy coating inhibits atmospheric deposits from accumulating on the shroud.

The low surface energy coating is a silicone polyurethane polymer. In particular embodiments, the low surface energy coating is formed from a polyalcohol having the structure of Formula (I):

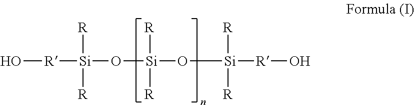

wherein R and R′ are independently alkyl, aryl, substituted alkyl, and substituted aryl; and n is from about 5 to about 1000.

In embodiments, the first shroud has a trailing edge with mixing lobes formed thereon. Generally, the first shroud has a ring airfoil shape.

In some embodiments, the first shroud comprises a skeleton and a skin, and the low surface energy coating is disposed on the skin.

In other embodiments, the surface having a low surface energy coating disposed thereon is an interior surface of the first shroud.

The wind turbine may further comprise an ejector shroud surrounding the first shroud and having an inlet end, the inlet end of the ejector shroud surrounding an outlet end of the first shroud.

Also disclosed in embodiments is a shrouded wind turbine having one or more components coated with a low surface energy coating. These components may be non-linear or curvilinear in fashion and particularly susceptible to the accumulation of atmospheric deposits such as water, rain, snow, sand, dirt, etc. In particular, the coated component is a wind turbine shroud.

A mixer/ejector wind turbine system (referenced herein as a “MEWT”) for generating power is disclosed that combines fluid dynamic ejector concepts, advanced flow mixing and control devices, and an adjustable power turbine. In some embodiments or versions, the MEWT is an axial flow turbine comprising, in order going downstream: an aerodynamically contoured turbine shroud having an inlet; a ring of stators within the shroud; an impeller having a ring of impeller blades “in line” with the stators; a mixer, associated with the turbine shroud, having a ring of mixing lobes extending downstream beyond the impeller blades; and an ejector comprising the ring of mixing lobes and a mixing shroud extending downstream beyond the mixing lobes. The turbine shroud, mixer and ejector are designed and arranged to draw the maximum amount of wind through the turbine and to minimize impact upon the environment (e.g., noise) and upon other power turbines in its wake (e.g., structural or productivity losses). Unlike existing wind turbines, the preferred MEWT contains a shroud with advanced flow mixing and control devices such as lobed or slotted mixers and/or one or more ejector pumps. The mixer/ejector pump presented is much different than used heretofore since in the disclosed wind turbine, the high energy air flows into the ejector inlets, and outwardly surrounds, pumps and mixes with the low energy air exiting the turbine shroud.

Also disclosed in other embodiments is a turbine comprising: a mixer shroud having an outlet and an inlet for receiving a primary fluid stream; and means for extracting energy from the primary fluid stream, the means for extracting energy being located within the turbine shroud; wherein the mixer shroud includes a set of high energy mixing lobes and a set of low energy mixing lobes; wherein each high energy mixing lobe forms an angle in the range of about of 5 to 65 degrees relative to the mixer shroud; and wherein each low energy mixing lobe forms an angle in the range of about 5 to 65 degrees relative to the mixer shroud or the turbine axis.

The high energy mixing lobe angle may be different from, greater than, less than, or equal to the low energy mixing lobe angle.

The turbine may further comprise an ejector shroud downstream from and coaxial with the mixer shroud, wherein a mixer shroud outlet extends into an ejector shroud inlet. The ejector shroud may itself have a ring of mixer lobes around its outlet.

The means for extracting energy may be an impeller or a rotor/stator assembly.

These and other non-limiting features or characteristics of the present disclosure will be further described below.

### BRIEF DESCRIPTION OF THE DRAWINGS

The following is a brief description of the drawings, which are presented for the purposes of illustrating the disclosure set forth herein and not for the purposes of limiting the same.

FIG. 1 is an exploded view of a first exemplary embodiment or version of a MEWT of the present disclosure.

FIG. 2 is a front perspective view of FIG. 1 attached to a support tower.

FIG. 3 is a front perspective view of a second exemplary embodiment of a MEWT, shown with a shrouded three bladed impeller.

FIG. 4 is a rear view of the MEWT of FIG. 3.

FIG. 5 is a cross-sectional view taken along line 5-5 of FIG. 4.

FIG. 6 is a perspective view of another exemplary embodiment of a wind turbine of the present disclosure having a pair of wing-tabs for wind alignment.

FIG. 7 is a front perspective view of another exemplary embodiment of a MEWT of the present disclosure. Here, both the turbine shroud and the ejector shroud have mixing lobes on their trailing edges.

FIG. 8 is a rear perspective view of the MEWT of FIG. 7.

FIG. 9 is a front perspective view of another exemplary embodiment of a MEWT according to the present disclosure.

FIG. 10 is a side cross-sectional view of the MEWT of FIG. 9 taken through the turbine axis.

FIG. 11 is a smaller view of FIG. 10.

FIG. 11A and FIG. 11B are magnified views of the mixing lobes of the MEWT of FIG. 9.

FIG. 12 is a perspective view of a skeleton-and-skin type construction for the wind turbine shrouds.

### DETAILED DESCRIPTION

A more complete understanding of the components, processes, and apparatuses disclosed herein can be obtained by reference to the accompanying figures. These figures are merely schematic representations based on convenience and the ease of demonstrating the present development and are, therefore, not intended to indicate the relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

A Mixer-Ejector Power System (MEPS) provides a unique and improved means of generating power from wind currents. A MEPS includes:
a primary shroud containing a turbine or bladed impeller, similar to a propeller, which extracts power from the primary stream; and
a single or multiple-stage mixer-ejector to ingest flow with each such mixer/ejector stage including a mixing duct for both bringing in secondary flow and providing flow mixing-length for the ejector stage. The inlet contours of the mixing duct or shroud are designed to minimize flow losses while providing the pressure forces necessary for good ejector performance.

The resulting mixer/ejectors enhance the operational characteristics of the power system by: (a) increasing the amount of flow through the system, (b) reducing the exit or back pressure on the turbine blades, and (c) reducing the noise propagating from the system.

The MEPS may include:
camber to the duct profiles to enhance the amount of flow into and through the system;
acoustical treatment in the primary and mixing ducts for noise abatement flow guide vanes in the primary duct for control of flow swirl and/or mixer-lobes tailored to diminish flow swirl effects;
turbine-like blade aerodynamics designs based on the new theoretical power limits to develop families of short, structurally robust configurations which may have multiple and/or counter-rotating rows of blades;
exit diffusers or nozzles on the mixing duct to further improve performance of the overall system;
inlet and outlet areas that are non-circular in cross section to accommodate installation limitations;
a swivel joint on its lower outer surface for mounting on a vertical stand/pylon allowing for turning the system into the wind;
vertical aerodynamic stabilizer vanes mounted on the exterior of the ducts with tabs or vanes to keep the system pointed into the wind; or
mixer lobes on a single stage of a multi-stage ejector system.

Referring to the drawings in detail, the figures illustrate alternate embodiments of Applicants' axial flow Wind Turbine with Mixers and Ejectors (“MEWT”). The present disclosure is directed towards to shrouded wind turbines and/or MEWTs having one or more components coated with a silicone polyurethane composition.

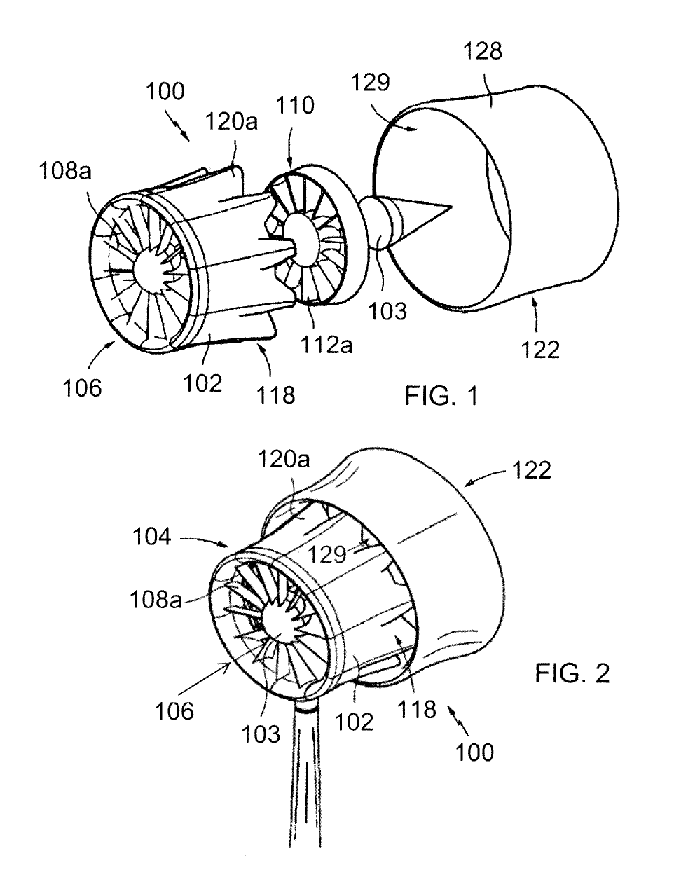

Referring to FIG. 1 and FIG. 2, the MEWT 100 is an axial flow turbine with:

a) an aerodynamically contoured turbine shroud 102;

b) an aerodynamically contoured center body 103 within and attached to the turbine shroud 102;

c) a turbine stage 104, surrounding the center body 103, comprising a stator ring 106 having stator vanes 108a and a rotor 110 having rotor blades 112a. Rotor 110 is downstream and “in-line” with the stator vanes, i.e., the leading edges of the impeller blades are substantially aligned with trailing edges of the stator vanes, in which:
i) the stator vanes 108a are mounted on the center body 103;
ii) the rotor blades 112a are attached and held together by inner and outer rings or hoops mounted on the center body 103;

d) a mixer indicated generally at 118 having a ring of mixer lobes 120a on a terminus region (i.e., end portion) of the turbine shroud 102, wherein the mixer lobes 120a extend downstream beyond the rotor blades 112a; and,

e) an ejector indicated generally at 122 comprising an ejector shroud 128, surrounding the ring of mixer lobes 120a on the turbine shroud, wherein the mixer lobes (e.g., 120a) extend downstream and into an inlet 129 of the ejector shroud 128.

The center body 103 of MEWT 100, as shown in FIG. 2, is desirably connected to the turbine shroud 102 through the stator ring 106, or other means. This construction serves to eliminate the damaging, annoying and long distance propagating low-frequency sound produced by traditional wind turbines as the wake from the turbine blades strike the support tower. The aerodynamic profiles of the turbine shroud 102 and ejector shroud 128 are aerodynamically cambered to increase flow through the turbine rotor.

Applicants have calculated, for optimum efficiency, the area ratio of the ejector pump 122, as defined by the ejector shroud 128 exit area over the turbine shroud 102 exit area, will be in the range of 1.5-3.0. The number of mixer lobes 120a would be between 6 and 14. Each lobe will have inner and outer trailing edge angles between 5 and 65 degrees. These angles are measured from a tangent line that is drawn at the exit of the mixing lobe down to a line that is parallel to the center axis of the turbine, as will be explained further herein. The primary lobe exit location will be at, or near, the entrance location or inlet 129 of the ejector shroud 128. The height-to-width ratio of the lobe channels will be between 0.5 and 4.5. The mixer penetration will be between 50% and 80%. The center body 103 plug trailing edge angles will be thirty degrees or less. The length to diameter (L/D) of the overall MEWT 100 will be between 0.5 and 1.25.

First-principles-based theoretical analysis of the preferred MEWT 100, performed by Applicants, indicate the MEWT can produce three or more times the power of its un-shrouded counterparts for the same frontal area; and, the MEWT 100 can increase the productivity of wind farms by a factor of two or more. Based on this theoretical analysis, it is believed the MEWT embodiment 100 will generate three times the existing power of the same size conventional open blade wind turbine.

A satisfactory embodiment 100 of the MEWT comprises: an axial flow turbine (e.g., stator vanes and impeller blades) surrounded by an aerodynamically contoured turbine shroud 102 incorporating mixing devices in its terminus region (i.e., end portion); and a separate ejector shroud 128 overlapping, but aft, of turbine shroud 102, which itself may incorporate mixer lobes in its terminus region. The ring 118 of mixer lobes 120a combined with the ejector shroud 128 can be thought of as a mixer/ejector pump. This mixer/ejector pump provides the means for consistently exceeding the Betz limit for operational efficiency of the wind turbine. The stator vanes' exit-angle incidence may be mechanically varied in situ (i.e., the vanes are pivoted) to accommodate variations in the fluid stream velocity so as to assure minimum residual swirl in the flow exiting the rotor.

Described differently, the MEWT 100 comprises a turbine stage 104 with a stator ring 106 and a rotor 110 mounted on center body 103, surrounded by turbine shroud 102 with embedded mixer lobes 120a having trailing edges inserted slightly in the entrance plane of ejector shroud 128. The turbine stage 104 and ejector shroud 128 are structurally connected to the turbine shroud 102, which is the principal load carrying member.

These figures depict a rotor/stator assembly for generating power. The term “impeller” is used herein to refer generally to any assembly in which blades are attached to a shaft and able to rotate, allowing for the generation of power or energy from wind rotating the blades. Exemplary impellers include a propeller or a rotor/stator assembly. Any type of impeller may be enclosed within the turbine shroud 102 in the wind turbine of the present disclosure.

In some embodiments, the length of the turbine shroud 102 is equal or less than the turbine shroud's outer maximum diameter. Also, the length of the ejector shroud 128 is equal or less than the ejector shroud's outer maximum diameter. The exterior surface of the center body 103 is aerodynamically contoured to minimize the effects of flow separation downstream of the MEWT 100. It may be configured to be longer or shorter than the turbine shroud 102 or the ejector shroud 128, or their combined lengths.

The turbine shroud's entrance area and exit area will be equal to or greater than that of the annulus occupied by the turbine stage 104, but need not be circular in shape so as to allow better control of the flow source and impact of its wake. The internal flow path cross-sectional area formed by the annulus between the center body 103 and the interior surface of the turbine shroud 102 is aerodynamically shaped to have a minimum area at the plane of the turbine and to otherwise vary smoothly from their respective entrance planes to their exit planes. The turbine and ejector shrouds' external surfaces are aerodynamically shaped to assist guiding the flow into the turbine shroud inlet, eliminating flow separation from their surfaces, and delivering smooth flow into the ejector entrance 129. The ejector 128 entrance area, which may alternatively be noncircular in shape, is greater than the mixer 118 exit plane area; and the ejector's exit area may also be noncircular in shape if desired.

Optional features of the preferred embodiment 100 can include: a power take-off, in the form of a wheel-like structure, which is mechanically linked at an outer rim of the impeller to a power generator; a vertical support shaft with a rotatable coupling for rotatably supporting the MEWT, the shaft being located forward of the center-of-pressure location on the MEWT for self-aligning the MEWT; and a self-moving vertical stabilizer fin or “wing-tab” affixed to upper and lower surfaces of the ejector shroud to stabilize alignment directions with different wind streams.

The MEWT 100, when used near residences can have sound absorbing material affixed to the inner surface of its shrouds 102, 128 to absorb and thus eliminate the relatively high frequency sound waves produced by the interaction of the stator 106 wakes with the rotor 110. The MEWT 100 can also contain blade containment structures for added safety. The MEWT should be considered to be a horizontal axis wind turbine as well.

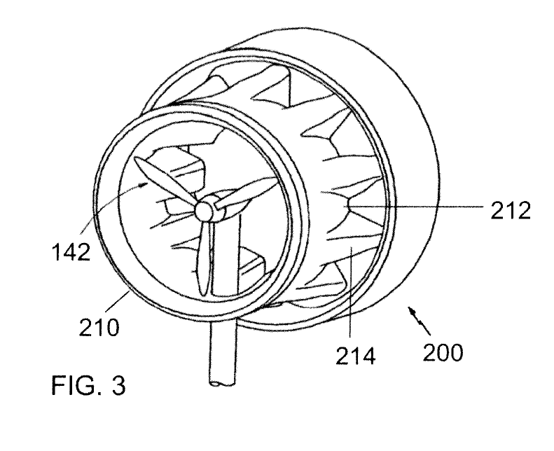

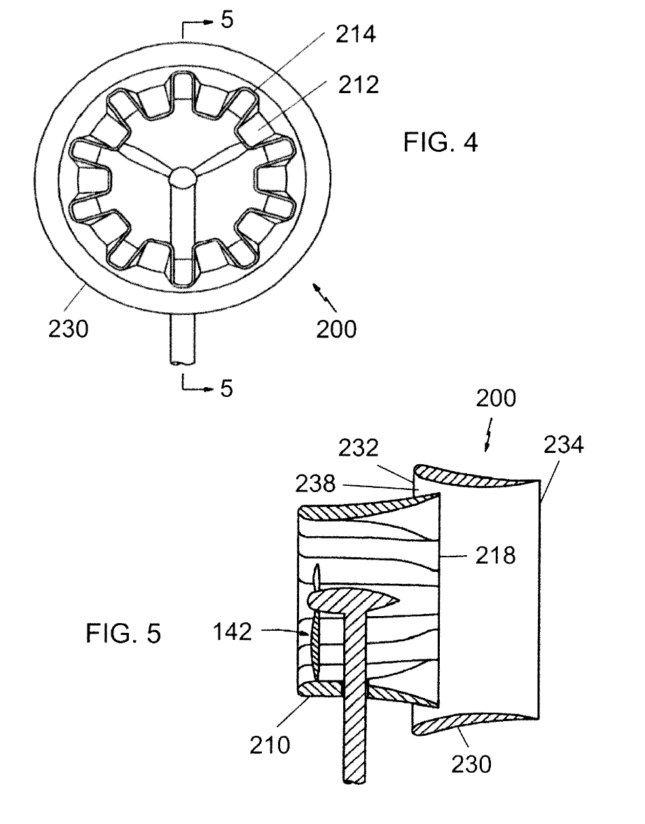

FIGS. 3-5 show a second exemplary embodiment of a shrouded wind turbine 200. The turbine 200 uses a propeller-type impeller 142 instead of the rotor/stator assembly as in FIG. 1 and FIG. 2. In addition, the mixing lobes can be more clearly seen in this embodiment. The turbine shroud 210 has two different sets of mixing lobes. Referring to FIG. 3 and FIG. 4, the turbine shroud 210 has a set of high energy mixing lobes 212 that extend inwards toward the central axis of the turbine. In this embodiment, the turbine shroud is shown as having 10 high energy mixing lobes. The turbine shroud also has a set of low energy mixing lobes 214 that extend outwards away from the central axis. Again, the turbine shroud 210 is shown with 10 low energy mixing lobes. The high energy mixing lobes alternate with the low energy mixing lobes around the trailing edge of the turbine shroud 210. From the rear, as seen in FIG. 4, the trailing edge of the turbine shroud may be considered as having a circular crenellated shape. The term “crenellated” or “castellated” refers to this general up-and-down or in-and-out shape of the trailing edge.

As seen in FIG. 5, the entrance area 232 of the ejector shroud 230 is larger than the exit area 234 of the ejector shroud. It will be understood that the entrance area refers to the entire mouth of the ejector shroud and not the annular area of the ejector shroud between the ejector shroud 230 and the turbine shroud 210. However, as seen further herein, the entrance area of the ejector shroud may also be smaller than the exit area 234 of the ejector shroud. As expected, the entrance area 232 of the ejector shroud 230 is larger than the exit area 218 of the turbine shroud 210, in order to accommodate the mixing lobes and to create an annular area 238 between the turbine shroud and the ejector shroud through which high energy air can enter the ejector.

The mixer-ejector design concepts described herein can significantly enhance fluid dynamic performance. These mixer-ejector systems provide numerous advantages over conventional systems, such as: shorter ejector lengths; increased mass flow into and through the system; lower sensitivity to inlet flow blockage and/or misalignment with the principal flow direction; reduced aerodynamic noise; added thrust; and increased suction pressure at the primary exit.

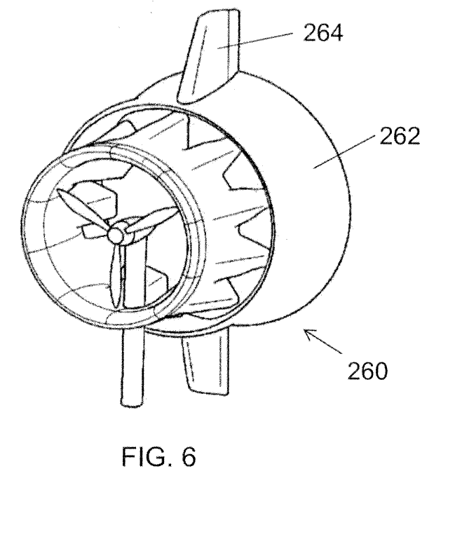

As shown in FIG. 6, another exemplary embodiment of a wind turbine 260 may have an ejector shroud 262 that has internal ribs shaped to provide wing-tabs or fins 264. The wing-tabs or fins 264 are oriented to facilitate alignment of the wind turbine 260 with the incoming wind flow to improve energy or power production.

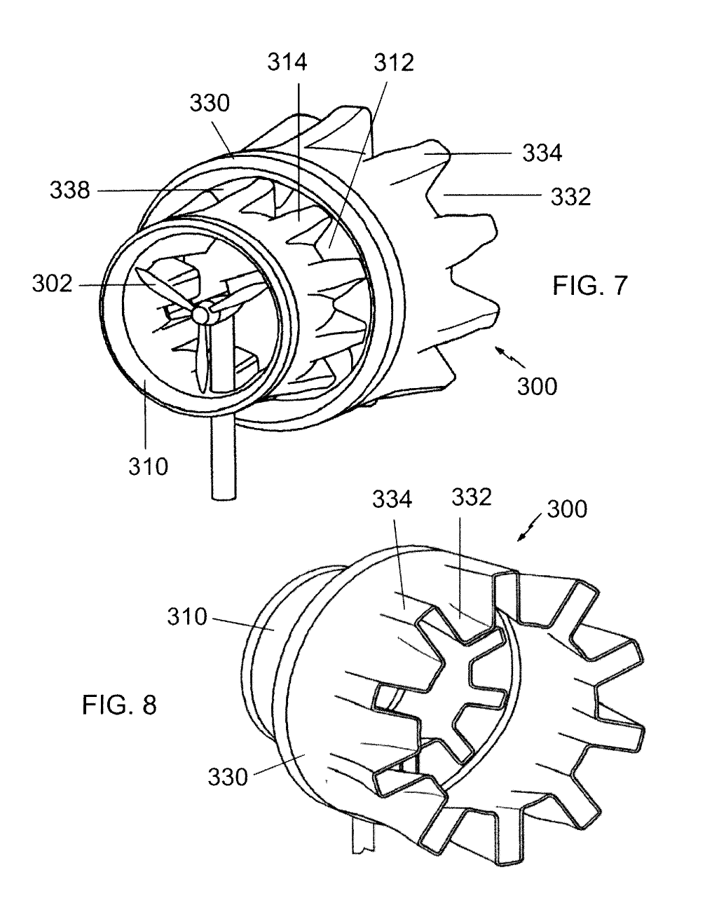

FIG. 7 and FIG. 8 illustrate another exemplary embodiment of a MEWT. The turbine 400 again uses a propeller-type impeller 302. The turbine shroud 310 has two different sets of mixing lobes. A set of high energy mixing lobes 312 extend inwards toward the central axis of the turbine. A set of low energy mixing lobes 314 extend outwards away from the central axis. In addition, the ejector shroud 330 is provided with mixing lobes on a trailing edge thereof. Again, two different sets of mixing lobes are present. A set of high energy mixing lobes 332 extend inwards toward the central axis of the turbine. A set of low energy mixing lobes 334 extend outwards away from the central axis. As seen in FIG. 8, the ejector shroud is shown here with 10 high energy mixing lobes and 10 low energy mixing lobes. The high energy mixing lobes alternate with the low energy mixing lobes around the trailing edge of the turbine shroud 330. Again, the trailing edge of the ejector shroud may be considered as having a circular crenellated shape.

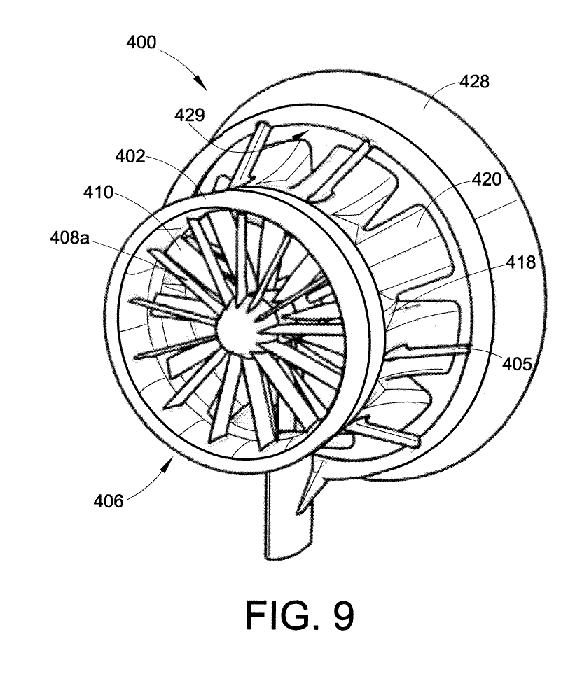

FIGS. 9-11 illustrate another exemplary embodiment of a MEWT. The MEWT 400 in FIG. 9 has a stator 408a and rotor 410 configuration for power extraction. A turbine shroud 402 surrounds the rotor 410 and is supported by or connected to the blades or spokes of the stator 408a. The turbine shroud 402 has the cross-sectional shape of an airfoil with the suction side (i.e. low pressure side) on the interior of the shroud. An ejector shroud 428 is coaxial with the turbine shroud 402 and is supported by connector members 405 extending between the two shrouds. An annular area is thus formed between the two shrouds. The rear or downstream end of the turbine shroud 402 is shaped to form two different sets of mixing lobes 418, 420. High energy mixing lobes 418 extend inwardly towards the central axis of the mixer shroud 402; and low energy mixing lobes 420 extend outwardly away from the central axis.

Free stream air indicated generally by arrow 406 passing through the stator 408a has its energy extracted by the rotor 410. High energy air indicated by arrow 429 bypasses the shroud 402 and stator 408a and flows over the turbine shroud 402 and directed inwardly by the high energy mixing lobes 418. The low energy mixing lobes 420 cause the low energy air exiting downstream from the rotor 410 to be mixed with the high energy air 429.

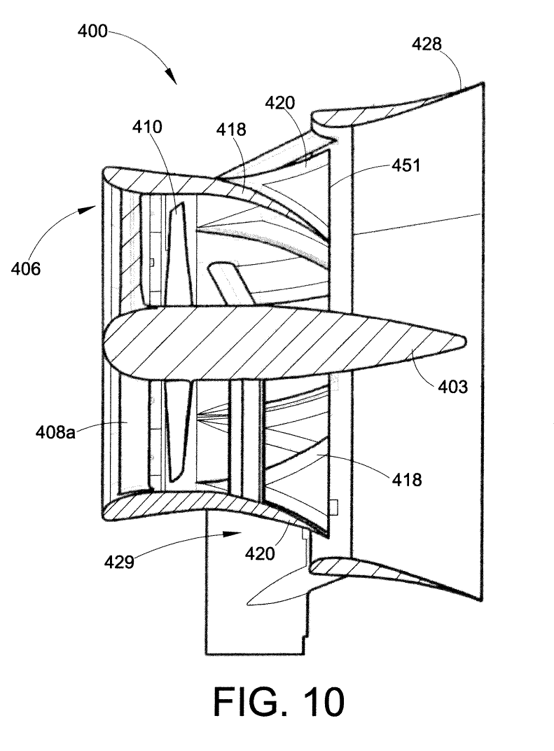

Referring to FIG. 10, the center nacelle 403 and the trailing edges of the low energy mixing lobes 420 and the trailing edge of the high energy mixing lobes 418 are shown in the axial cross-sectional view of the turbine of FIG. 9. The ejector shroud 428 is used to direct inwardly or draw in the high energy air 429. Optionally, nacelle 403 may be formed with a central axial passage therethrough to reduce the mass of the nacelle and to provide additional high energy turbine bypass flow.

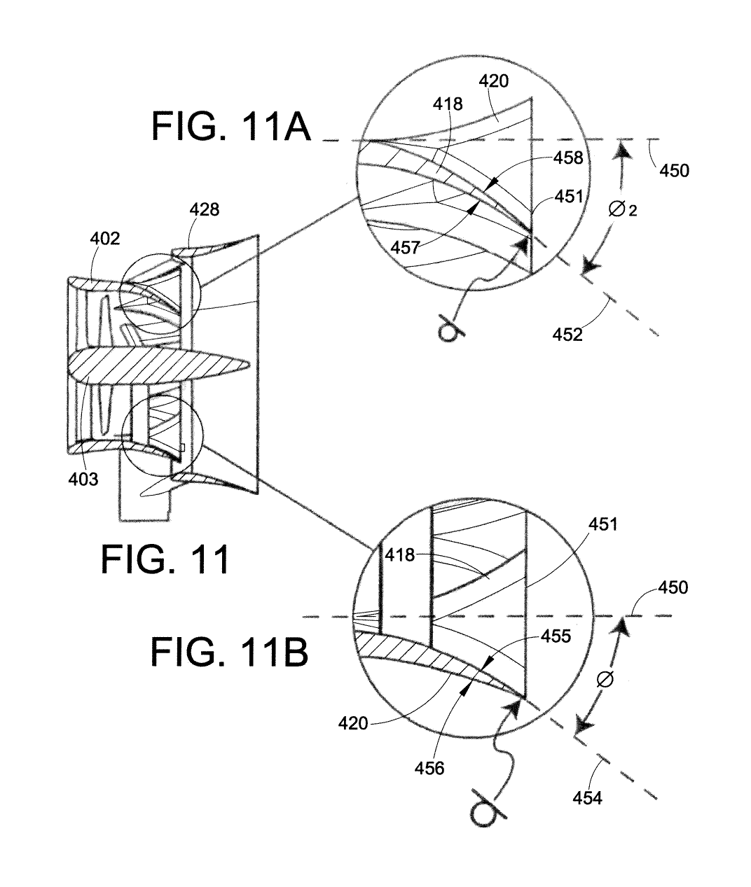

In FIG. 11A, a tangent line 452 is drawn along the interior trailing edge indicated generally at 457 of the high energy mixing lobe 418. A rear plane 451 of the turbine shroud 402 is present. A line 450 is formed normal to the rear plane 451 and tangent to the point where a low energy mixing lobe 420 and a high energy mixing lobe 418 meet. An angle Ø₂ is formed by the intersection of tangent line 452 and line 450. This angle Ø₂ is between 5 and 65 degrees. Put another way, a high energy mixing lobe 418 forms an angle Ø₂ between 5 and 65 degrees relative to the turbine shroud 402.

In FIG. 11B, a tangent line 454 is drawn along the interior trailing edge indicated generally at 455 of the low energy mixing lobe 420. An angle Ø is formed by the intersection of tangent line 454 and line 450. This angle Ø is between 5 and 65 degrees. Put another way, a low energy mixing lobe 420 forms an angle Ø between 5 and 65 degrees relative to the turbine shroud 402.

Generally, the present disclosure relates to a low surface energy coating which is placed on the surfaces (interior or exterior) of one or more components of the wind turbine. In particular, it is contemplated that the coating will be used on the shroud(s) on a wind turbine. This coating allows the surface to shed atmospheric deposits such as water, ice, snow, sand, dirt, etc., more easily. For example, the buildup of ice, particularly on the impeller blades, can be dangerous because the rotational speed of the blades can change, causing the ice to be thrown from the blades and damaging the wind turbine and possibly people or animals under the wind turbine. In this regard, the low surface energy coating can be considered an anti-icing system.

In addition, the shrouded wind turbine partially achieves high energy generation efficiency due to the aerodynamic properties of the shroud(s). The shroud(s) causes wind to have a greater velocity passing through the interior of the shroud and through the impeller. Also, laminar airflow is generally desirable to obtain optimum efficiency. Any material which accretes on the surfaces of the wind turbine, such as the impeller blades or the shroud(s), will change the aerodynamic shape of the shroud(s) and modify the airflow through the wind turbine. This change in the airflow can reduce the energy generating efficiency of the wind turbine. Materials which can accrete may vary depending on geography and climate, and such materials may include water, rain, ice, snow, sand, dirt, etc. In particular, the shroud(s) provide additional surfaces that are not present on conventional HAWTs, so that such HAWTs typically do not need such a coating. Those surfaces may include the interior surface of the shroud and the surfaces of any mixing lobes present on the shroud(s).

The coating is particularly useful on wind turbine shrouds that are built using a skeleton-and skin structure. This allows the wind turbine shroud to be strong but light weight, which makes it easier to raise the shroud to a given height and possible reduces the volume of the shroud itself.

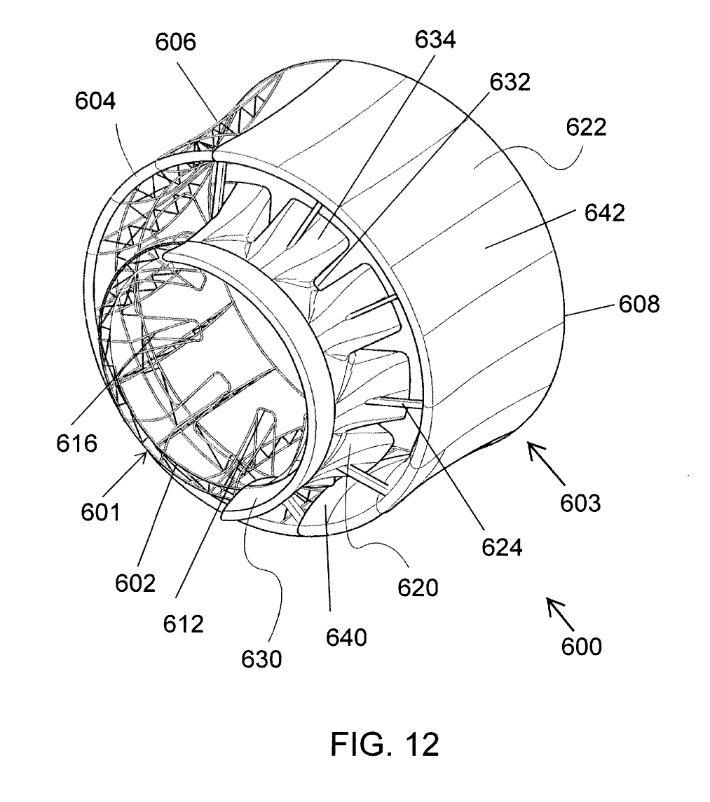

FIG. 12 illustrates a wind turbine 600 which has been constructed using an skeleton-and-skin structure. A turbine shroud skeleton 601 includes a turbine shroud front ring structure 602 and a turbine shroud mixing structure 612. A plurality of first internal ribs 616 connects the turbine shroud front ring structure 602 and the turbine shroud mixing structure 612 together. The front ring structure 602 and the mixing structure 612 are generally parallel to each other and perpendicular to the turbine axis. A turbine skin 620 partially covers the turbine shroud skeleton 601. Similarly, an ejector shroud skeleton 603 includes an ejector shroud front ring structure 604 and a ejector shroud rear ring structure 608. A plurality of first internal ribs 606 connects the ejector shroud front ring structure 604 and the ejector shroud rear ring structure 608 together. The front ring structure 604 and the rear ring structure 608 are generally parallel to each other and perpendicular to the turbine axis. An ejector skin 622 partially covers the ejector shroud skeleton 603. Support members 624 connect the turbine shroud skeleton 601 to the ejector shroud skeleton 603. The resulting turbine shroud 630 has two sets of mixing lobes, high energy mixing lobes 632 that extend inwards toward the central axis of the turbine, and low energy mixing lobes 634 that extend outwards away from the central axis. The ejector shroud is shown here with both an interior surface 640 and an exterior surface 642.

The skin 620, 622, respectively, of both the turbine shroud and the ejector shroud may be generally formed of any polymeric film or fabric material. Exemplary materials include polyurethane, polyfluoropolymers, and multi-layer films of similar composition. Stretchable fabrics, such as spandex-type fabrics or polyurethane-polyurea copolymer containing fabrics, may also be employed.

Polyurethane films are tough and have good weatherability. The polyester-type polyurethane films tend to be more sensitive to hydrophilic degradation than polyether-type polyurethane films. Aliphatic versions of these polyurethane films are generally ultraviolet resistant as well

Exemplary polyfluoropolymers include polyvinyldidene fluoride (PVDF) and polyvinyl fluoride (PVF). Commercial versions are available under the trade names KYNAR® and TEDLAR®. Polyfluoropolymers generally have very low surface energy, which allow their surface to remain somewhat free of dirt and debris, as well as shed ice more readily as compared to materials having a higher surface energy.

The skin may be reinforced with a reinforcing material. Examples of reinforcing materials include but are not limited to highly crystalline polyethylene fibers, paramid fibers, and polyaramides.

The turbine shroud skin and ejector shroud skin may independently be multi-layer, comprising one, two, three, or more layers. Multi-layer constructions may add strength, water resistance, UV stability, and other functionality. However, multi-layer constructions may also be more expensive and add weight to the overall wind turbine.

The front ring structure, mixing structure, and rear ring structure of either shroud may be comprised of rigid materials. Rigid materials include, but are not limited to, polymers, metals, and mixtures thereof. Other rigid materials such as glass reinforced polymers may also be employed. Rigid surface areas around fluid inlets and outlets may improve the aerodynamic properties of the shrouds. The rigid surface areas may be in the form of panels or other constructions. Film/fabric composites are also contemplated along with a backing, such as foam.

A low surface energy coating can be applied to an exterior surface, such as the skin of the skeleton-and-skin structure. The low surface energy coating is a silicone polyurethane polymer. As described further herein, the silicone polyurethane polymer can be considered to act as a block copolymer. Generally speaking, the polymer includes a silicone block and a urethane block. Described another way, the polymer is a polyurethane that includes silicon atoms polymerized into the backbone of the polymer.

Polyurethane polymers are typically made from two reactants: polyalcohols (i.e. containing at least two hydroxyl groups) and polyisocyanates (i.e. containing at least two isocyanate groups). The hydroxyl group has a reactive hydrogen atom. During polymerization, the hydroxyl (—OH) groups react with the isocyanate groups (—N═C═O) to form a polyurethane.

The stoichiometry of a polyurethane reaction is usually defined as the number of equivalents of active hydrogen groups divided by the number of equivalents of isocyanate groups multiplied by 100. In shorthand, the formula is [—OH]/[—NCO]*100. Typical systems utilize a stoichiometry of 95 to 105. A stoichiometry of 95 represents a 5% excess of isocyanate, which ensures that all of the polyol, or soft component, is reacted, providing a fully cured material. A stoichiometry of 105 may be used to obtain a slightly softer material, with the excess polyol acting as a plasticizer.

The silicone polyurethane polymer of the present disclosure is formed by the reaction of a silicone polyol and a polyisocyanate. The general structure of a polyisocyanate is R—(NCO)ₙ, where n is at least two, and R is an aliphatic or aromatic group. The polyisocyanate may be also be a prepolymer. The prepolymer may be a blend of copolymers or a polymer. Furthermore, the prepolymer may comprise polyether, polyester, or polybutadiene components.

The terms “aromatic” refers to an array of atoms having a valence of at least one and comprising at least one aromatic group. The array of atoms may include heteroatoms such as nitrogen, sulfur, selenium, silicon and oxygen, or may be composed exclusively of carbon and hydrogen. The aromatic group may also include nonaromatic components. For example, a benzyl group is an aromatic group that comprises a phenyl ring (the aromatic component) and a methylene group (the nonaromatic component). Exemplary aromatic groups include, but are not limited to, phenyl, pyridyl, furanyl, thienyl, naphthyl, and biphenyl.

The term “aliphatic” refers to an array of atoms which is not aromatic. The aliphatic group may include heteroatoms such as nitrogen, sulfur, and oxygen in the array, or may be composed exclusively of carbon and hydrogen. The aliphatic group may have single bonds, double bonds, or triple bonds. Exemplary aliphatic groups include, but are not limited to, diphenylmethylene and isophorone.

The term “alkyl” refers to a linear or branched array of atoms that is composed exclusively of carbon and hydrogen. The array of atoms may include single bonds, double bonds, or triple bonds (typically referred to as alkane, alkene, or alkyne). Exemplary alkyl groups include, but are not limited to, methyl, ethyl, and isopropyl.

The term “aryl” refers to an array of atoms which is aromatic and which is composed exclusively of carbon and hydrogen. An exemplary aryl group is phenyl.

The term “substituted alkyl” refers to an alkyl group on which one or more hydrogen atoms is replaced with another atom, which is typically a halogen atom.

The term “substituted aryl” refers to an aryl group on which one or more hydrogen atoms is replaced with another array of atoms. The hydrogen atom(s) may be replaced with an alkyl, halogen, or oxyalkyl group. Exemplary substituted aryl groups include, but are not limited to, tolyl, 4-trifluoromethylphenyl, 4-chloromethylphen-1-yl, and 3-trichloromethylphen-1-yl (3-CCl₃Ph-)

Aromatic polyisocyanates which may be used in the present disclosure include, but are not limited to, toluene diisocyanate (TDI); diphenyl-methane-diisocyanate (MDI); naphthalene-1,5-diisocyanate (NDI); m- and p-phenylene diisocyanate; toluene-2,4- and -2,6-diisocyanate; diphenylmethane-4,4′-diisocyanate; chlorophenylene-2,4-diisocyanate; naphthalene-1,5-diisocyanate; 3-methyldiphenylmethane-4,4′-diisocyanate; 4,4′-diisocyanate-3,3′-dimethyldiphenylmethane; diphenyl ether diisocyanate; and 3-methyldiphenylmethane-4,4′-diisocyanate. Generally, aromatic isocyanates exhibit fast reaction times and good physical properties, but tend to have poor light fastness (i.e., discoloration due to UV light).

Aliphatic polyisocyanates which may be used in the present disclosure include, but are not limited to, hexamethylene diisocyanate (HDI); isophorone diisocyanate (IPDI); tetramethylene diisocyanate; octamethylene diisocyanate; decamethylene diisocyanate; dodecamethylene diisocyanate; tetradecamethylene diisocyanate; derivatives of lysine diisocyanate; tetramethylxylylene diisocyanate; trimethylhexane diisocyanate or tetramethylhexane diisocyanate; cycloaliphatic diisocyanates such as 1,4-, 1,3- or 1,2-diisocyanatocyclohexane; 4,4-di(isocyanatocyclohexyl)methane; 1-isocyanato-3,3,5-trimethyl-5-(isocyanatemethyl)-cyclohexane-(isophorone diisocyanate) or 2,4- or 2,6-diisocyanato-1-methylcyclohexane. Aliphatic isocyanates generally exhibit good light fastness and UV stability, but are slower to react and produce softer polymers than the aromatic isocyanates.

The silicone polyurethane polymer of the present disclosure is formed from a silicone polyol. The silicone polyol contains at least one silicon atom and at least two hydroxyl groups. In embodiments, the silicone polyol has the structure of Formula (I):

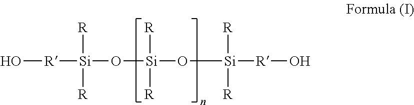

wherein R and R′ are independently alkyl, aryl, substituted alkyl, and substituted aryl; and n is from about 5 to about 1000.

Methods of making the silicone polyurethane polymers are well known in the art. The polyisocyanate and silicone polyol are reacted to form a silicone polyurethane polymer. The silicone portion chains are in the backbone of the polymer and have a low surface energy, which makes it more difficult for rain and snow to adhere to the surface of the wind turbine shroud.

The silicone polyurethane polymer can also be coated or applied to a surface on a wind turbine shroud using means known in the art. For example, the polymer can be suspended in a dispersion and painted onto the surface of the wind turbine shroud.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A wind turbine comprising:
an impeller; and
a first shroud located concentrically about the impeller;
wherein the first shroud includes a surface having a low surface energy coating disposed thereon.

2. The wind turbine of claim 1, wherein the low surface energy coating is a silicone polyurethane polymer.

3. The wind turbine of claim 1, wherein the low surface energy coating is formed from a polyalcohol having the structure of Formula (I): 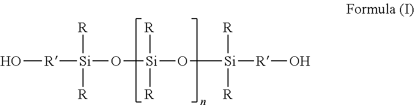
wherein R and R′ are independently alkyl, aryl, substituted alkyl, and substituted aryl; and n is from about 5 to about 1000.

4. The wind turbine of claim 1, wherein the first shroud has a trailing edge with mixing lobes formed thereon.

5. The wind turbine of claim 1, wherein the first shroud has a ring airfoil shape.

6. The wind turbine of claim 1, wherein the first shroud comprises a skeleton and a skin, and the low surface energy coating is disposed on the skin.

7. The wind turbine of claim 1, wherein the surface having a low surface energy coating disposed thereon is an interior surface of the first shroud.

8. The wind turbine of claim 1, wherein the wind turbine further comprises an ejector shroud surrounding the first shroud and having an inlet end, the inlet end of the ejector shroud surrounding an outlet end of the first shroud.

9. The wind turbine of claim 1, wherein the low surface energy coating inhibits atmospheric deposits from accumulating on the first shroud.

10. A shrouded wind turbine having one or more components coated with a low surface energy coating.

11. The wind turbine of claim 10, wherein the low surface energy coating is a silicone polyurethane polymer.

12. The wind turbine of claim 10, wherein the low surface energy coating is formed from a polyalcohol having the structure of Formula (I): 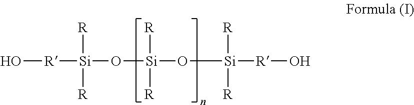
wherein R and R′ are independently alkyl, aryl, substituted alkyl, and substituted aryl; and n is from about 5 to about 1000.

13. The wind turbine of claim 10, wherein the coated component is a wind turbine shroud.

14. The wind turbine of claim 13, wherein the wind turbine shroud has a ring airfoil shape.

15. The wind turbine of claim 13, wherein the wind turbine shroud comprises a skeleton and a skin, and the low surface energy coating is disposed on the skin.

16. The wind turbine of claim 15, wherein an interior surface of the wind turbine shroud is coated with the low surface energy coating.

17. The wind turbine of claim 15, wherein an exterior surface of the wind turbine shroud is coated with the low surface energy coating.

18. The shrouded wind turbine of claim 10, wherein the low surface energy coating inhibits atmospheric deposits from accumulating on the one or more components of the shrouded wind turbine.
